(19) United States
(12) Patent Application Publication
(10) Pub. No.: US 2002/0186964 A1
(43) Pub. Date: Dec. 12, 2002

(54) Data storage drive interfaces for digital image systems

(75) Inventors: Louis J. Skarda JR., Lake Elmo, MN (US); Kent R. Schoenherr, Stillwater, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 09/877,563

(22) Filed: Jun. 8, 2001

(51) Int. Cl. H04N 5/76; H04N 5/225

(52) U.S. Cl. 386/118; 348/207.99

(57) ABSTRACT

Data recording drives, most preferably (but not necessarily) those commercially available under the DATAPLAY trade name (“DataPlay drives”), may be used as the storage system for digital image systems such as digital video (DV) systems or digital still cameras (DSCs). Preferred interfaces include commercially available flash memory slots of various types, Universal Serial Bus (USB) interfaces in digital image systems configured to have USB host capabilities, and those conforming to the IEEE 1394 (“FireWire”) standard

### TECHNICAL FIELD

This invention concerns data storage devices suitable for use with digital image systems such as digital cameras.

### BACKGROUND

Commercially popular embodiments of digital image systems, such as digital video (DV) or digital still cameras (DSCs), generally require removable flash memory cards to store captured images. Because of the high cost of flash memory cards (roughly U.S. $2/megabyte in 2001), users generally cannot afford to purchase enough flash memory capacity to let them operate without capacity limitations. Quite often users are forced to select a lower resolution photo mode (i.e., smaller file size, lower image quality) to fit all of their images in the limited flash memory space.

### DISCLOSURE OF INVENTION

The invention is a data storage system comprising, in combination, a digital image system, a data recording drive, and an interface to the data recording drive that is electrically and mechanically compatible with the digital image system.

The digital image system may be a digital video (DV) system, a digital still camera (DSC), or some other form of digital image system.

The data recording drive may be an optical or magneto-optical recording drive (preferably, but not necessarily, a DATAPLAY drive), or a magnetic recording drive (such as a POCKET ZIP drive, or any small diameter magnetic hard disk drive such as the common two inch diameter hard disk drive).

In one embodiment, the interface may be compatible with flash memory capability in the digital image system, such as those known by any of the tradenames COMPACT FLASH, SMART MEDIA, MEMORY STICK SECURE DIGITAL, or MULTIMEDIA CARD.

In another embodiment, the interface is compatible with Universal Serial Bus data transfer capability in the digital image system, and the digital image system further comprises capability to act as a host for data over the Universal Serial Bus. In yet another embodiment, the interface is compatible with data transfer capability in the digital image system meeting the IEEE 1394 standard and future versions of that standard.

The system may also include a mount configured to attach to the digital image system, and on which the data recording drive may be removably mounted. The mount may be permanently or temporarily attached to the digital image system.

The system may further comprise circuitry to translate between the data recording drive and the digital image system. Such circuitry may be located in the digital image system or in the data recording drive.

A power source may be located in the digital image system, in the data recording drive, or both.

### DESCRIPTION OF THE FIGURES

FIG. 1 is an upper perspective view of one embodiment of the invention.

FIG. 2 is an exploded perspective view of the embodiment of FIG. 1.

FIG. 3 is a lower perspective view of the embodiment of FIG. 1.

FIG. 4 is an upper perspective view of another embodiment of the invention.

FIG. 5 is an exploded perspective view of the embodiment of FIG. 4.

FIG. 6 is a lower perspective view of the embodiment of FIG. 4.

### DETAILED DESCRIPTION

In general terms, the invention permits data recording drives, most preferably (but not necessarily) those commercially available under the DATAPLAY trade name (“DataPlay drives”) and compatible media, to be used as the storage system for digital image systems, including (without limitation) digital video (DV) systems or digital still cameras (DSCs).

DataPlay drives, and the media compatible with them, are believed to be similar to those disclosed in W0072312A2 entitled “Removable Optical Storage Device and System” and W0079526A1 entitled “Combination Mastered and Writeable Medium and Use in Electronic Book Internet Appliance,” the entire contents of which are incorporated by reference.

In one embodiment, a data drive is combined with, and connected to, a digital still camera that is configured to have commercially available flash memory capabilities. Such capabilities most preferably (but not necessarily) are those associated with the trade names COMPACT FLASH (“Compact Flash”), SMART MEDIA (“Smart Media”), MEMORY STICK (“Memory Stick”), SECURE DIGITAL (“Secure Digital” or “SD”), or MULTIMEDIA CARD (“MultiMedia Card” or “MMC”). In another embodiment, a data recording drive having a Universal Serial Bus (USB) interface can be connected to a DSC that is configured to have USB host capabilities. In yet another embodiment, a data recording drive having an interface conforming to the IEEE 1394 interface standard (sometimes known under the tradename FIREWIRE) (“FireWire”) can be connected to a DV system.

The electrical interface of the data recording drive to the digital image system is accomplished by direct connection of the data recording drive to the digital image system by means of a short interface cable. The short interface cable has a connection end that is electrically and mechanically compatible with the digital image system. Special electrical circuitry (discrete components, programmable components, firmware, and the like) may be required to translate between the data recording file structure (e.g, the IDE file structure) interface and the digital image system. Such special components may be located either in the enclosure of the data recording drive, in the digital image system connection end of the interface cable, or split between these two locations.

The mechanical interface of the data recording drive enclosure to the digital image system is accomplished by utilizing any apparatus which connects the data recording drive to the digital image system. The location of connection is not critical to the scope of the invention. In a preferred (but not required) embodiment, the apparatus remains attached to the digital image system, allowing for a quick connection of the data recording drive at anytime.

Power for the data recording drive and interface circuitry may come from batteries located in the data recording drive enclosure or from the digital image system. It is also possible to derive power from a combination of both these sources.

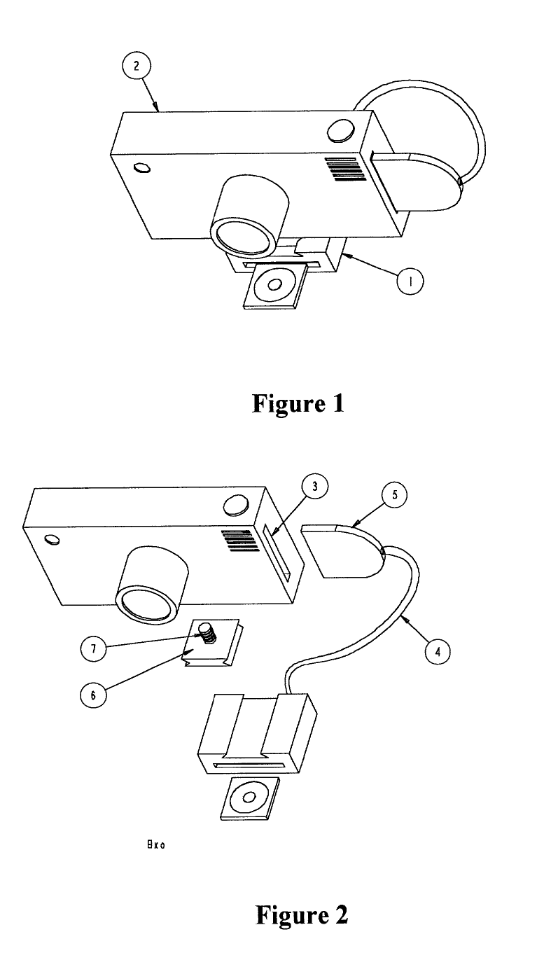

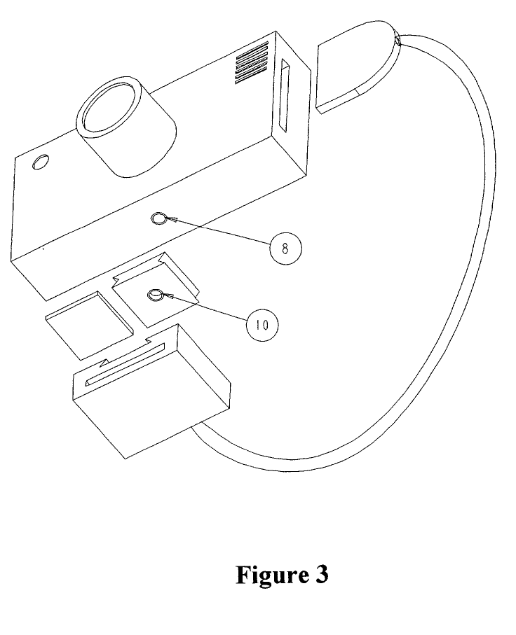

FIGS. 1-3 are schematic illustrations of the flash memory embodiment of the invention. The electrical interface of the data recording drive 1 to the digital image system 2 is accomplished by direct connection of the data recording drive to the Flash memory slot 3 of the digital image system 2 by means of a short interface cable 4. The short interface cable has a connection end 5 that is electrically and mechanically compatible with the Compact Flash or Smart Media host slot on the digital image system 2. Special electrical circuitry and firmware is required to translate between the data recording drive's file structure interface and the flash memory interface. This circuitry and firmware may be located either in the enclosure of the data recording drive, in the Flash connection end 5 of the interface cable, or split between these two locations. The mechanical interface of the data recording drive enclosure to the digital image system 2 is accomplished by utilizing a slide on apparatus 6 connected to the digital image system 2 by means of a threaded post 7 into the receiving DSC tripod hole 8. The slide on apparatus 6 can remain permanently attached to the digital image system 2 allowing for a quick connection of the data recording drive 1 at anytime. A receiving threaded hole 10 in the slide on apparatus is available for connection of the digital image system 2 to a tripod or other attachments. Power for the data recording drive and interface circuitry may come from batteries located in the data recording drive enclosure or from the digital image system 2 through the flash memory card interface. It would also be possible to derive power from a combination of both these sources.

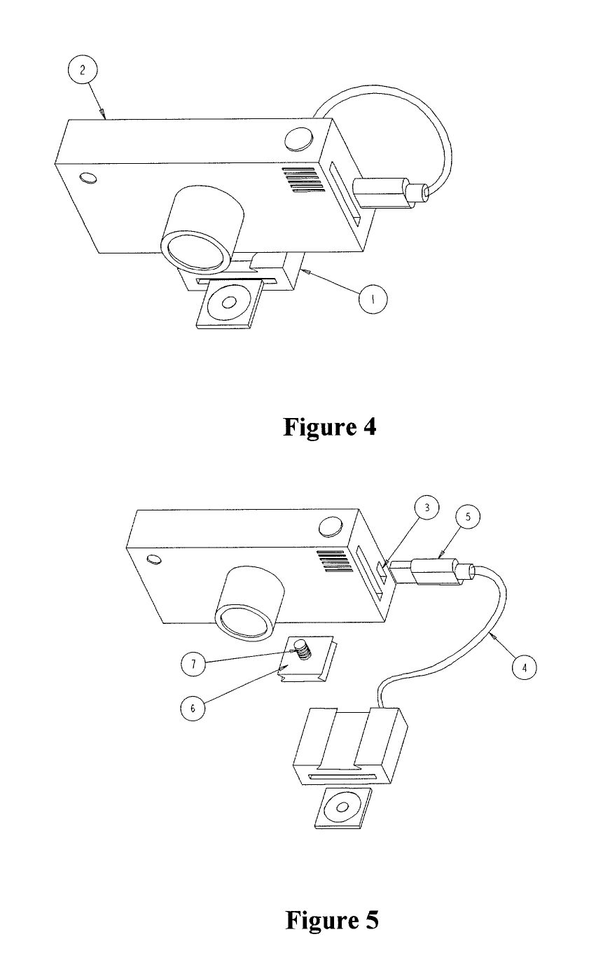

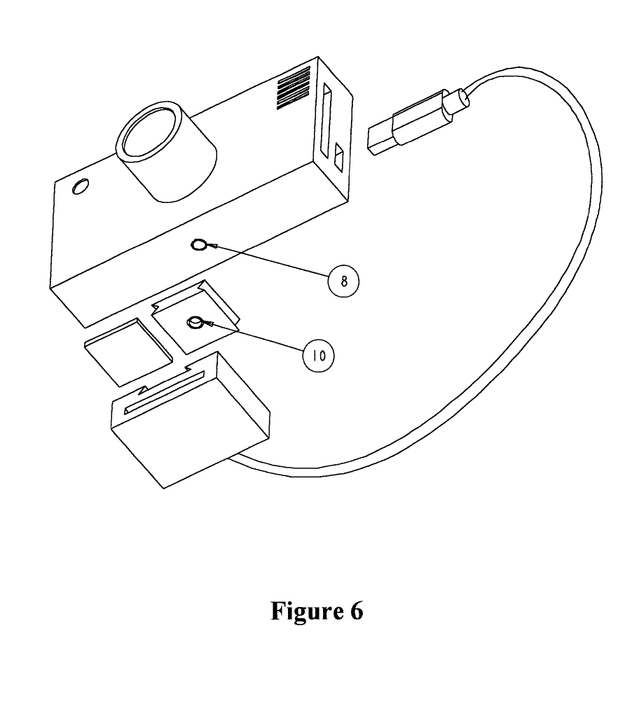

FIGS. 4-6 are schematic illustrations of the USB embodiment of the invention. The electrical interface of the data recording drive 1 to the digital image system 2 is accomplished by direct connection of the data recording drive to the USB slot 3 of the digital image system 2 by means of a short USB cable 4 with a USB connector 5. The digital image system 2 must be capable of configuring as a USB host. In addition, the digital image system 2 must be capable of streaming the captured photo image data directly to the DataPlay drive device via the USB channel. The capability for a digital image system 2 in the form of a DSC to be configured as both a device and as a host is not commercially available as of the filing date of this application; however, a technology standard for such a device is known and expected to be implemented in DSCs at some point. Firmware specific to the particular technology that becomes commercially available is expected to be required to accomplish direct transfer of photo image data directly to the USB data recording device.

The mechanical interface of the data recording drive enclosure to the digital image system 2 is accomplished by utilizing a slide on apparatus 6 connected to the digital image system 2 by means of a threaded post 7 into the receiving digital image system 2 tripod hole 8. The slide on apparatus 6 can remain permanently attached to the digital image system 2 allowing for a quick connection of the data recording drive 1 at anytime. A receiving threaded hole 10 in the slide on apparatus is available for connection of the digital image system 2 to a tripod or other attachments.

Power for the data recording drive and interface circuitry may come from batteries located in the data recording drive enclosure or from the digital image system 2 through the USB interface. It would also be possible to derive power from a combination of both these sources.

The invention provides a significantly lower cost memory alternative for digital image system users. For example, the removable disks for DataPlay drives are expected to cost less than U.S. $0.02/megabyte in 2002. The invention also provides appropriate interfaces that are compatible with the majority of digital image systems commercially available now and in the future. For example, the flash memory embodiment provides utility similar to prior art flash memory cards. The USB embodiment is compatible with digital image systems that have self-host USB capabilities and are able to stream captured photo image data directly to the DataPlay drive via the USB channel. The FireWire embodiment is suitable for low cost and immediate distribution of video segments from the DV system to a DataPlay drive. When connecting a DV system with a data recording drive, it may be desirable to employ video compression in the connector or drive.

We claim:

1. A data storage system, comprising, in combination: a digital image system, a data recording drive, and an interface to the data recording drive that is electrically and mechanically compatible with the digital image system.

2. The system of claim 1, in which the digital image system is a digital still camera.

3. The system of claim 1, in which the digital image system is a digital video system.

4. The system of claim 1, in which the drive is an optical drive.

5. The system of claim 1, in which the drive is a magnetic drive.

6. The system of claim 4, in which the optical drive is a DATAPLAY drive.

7. The system of claim 1, in which the interface is compatible with flash memory capability in the digital image system.

8. The system of claim 1, in which the interface is compatible with COMPACT FLASH memory capability in the digital image system.

9. The system of claim 1, in which the interface is compatible with SMART MEDIA memory capability in the digital image system.

10. The system of claim 1, in which the interface is compatible with MEMORY STICK memory capability in the digital image system.

11. The system of claim 1, in which the interface is compatible with SECURE DIGITAL memory capability in the digital image system.

12. The system of claim 1, in which the interface is compatible with MULTIMEDIA CARD memory capability in the digital image system.

13. The system of claim 1, in which the interface is compatible with Universal Serial Bus data transfer capability in the digital image system, and the digital image system further comprises capability to act as a host for data over the Universal Serial Bus.

14. The system of claim 1, in which the interface is compatible with IEEE 1394 capability in the digital image system.

15. The system of claim 1, further comprising a mount configured to attach to the digital image system and on which the data recording drive may be removably mounted.

16. The system of claim 15, in which the mount is permanently attached to the digital image system.

17. The system of claim 15, in which the mount is temporarily attached to the digital image system.

18. The system of claim 1, further comprising circuitry to translate between the data recording drive and the digital image system.

19. The system of claim 18, in which the circuitry is located in the digital image system.

20. The system of claim 18, in which the circuitry is located in the data recording drive.

21. The system of claim 1, further comprising a power source located in the digital image system.

22. The system of claim 1, further comprising a power source located in the data recording drive.

23. The system of claim 1, further comprising a first power source located in the digital image system and a second power source located in the data recording drive.

24. The system of claim 1, wherein the drive is a POCKET ZIP drive.

25. A data storage system, comprising, in combination: a digital image system, a DATAPLAY optical recording drive, an interface to the drive that is electrically and mechanically compatible with the digital image system, and a mount configured to attach to the digital imaging system and on which the drive may be removably mounted.
